(19) United States
(12) Patent Application Publication
(10) Pub. No.: US 2005/0281130 A1
(43) Pub. Date: Dec. 22, 2005

(54) Electric mixer

(75) Inventor: Pan-Chung Hsieh, Tou-Liu City (TW)

Correspondence Address: BRUCE H. TROXELL, SUITE 1404, 5205 LEESBURG PIKE, FALLS CHURCH, VA, 22041, US

(73) Assignee: Lee Yeong Industrial Co., Ltd.

(21) Appl. No.: 10/968,061

(22) Filed: Oct. 20, 2004

(30) Foreign Application Priority Data
Jun. 18, 2004 (TW) 93209717

(51) Int. Cl. A47J 43/044

(52) U.S. Cl. 366/129

(57) ABSTRACT

An electric mixer including a driving mechanism and a transmission mechanism. A first connecting tube, a second connecting tube and a third connecting tube which are parallelly arranged under the transmission mechanism at intervals. The first connecting tube is positioned in the middle of the electric mixer for connecting with and driving a mixing rod and a paddle. The second and third connecting tubes are respectively disposed on two sides of the first connecting tube. Each of the second and third connecting tubes serves to connect with and drive another mixing rod and another paddle. A smaller first gap is defined between the first middle connecting tube and any of the second and third lateral connecting tubes. A larger second gap is defined between the second and third connecting tubes. One mixing rod and paddle thereof can be connected with any of the first, second and third connecting tubes to form a single-paddle electric mixer. Alternatively, two mixing rods and paddles thereof can be respectively connected with the second and third connecting tubes to form a twin-paddle electric mixer with the larger gap. Still alternatively, two mixing rods and paddles thereof can be respectively connected with the first middle connecting tube and any of the second and third connecting tubes to form a twin-paddle electric mixer with the smaller gap.

### BACKGROUND OF THE INVENTION

The present invention is related to an electric mixer. One or two mixing rods and paddles thereof can be assembled to form a single-paddle electric mixer or a twin-paddle electric mixer. In addition, the two mixing rods and paddles thereof can be selectively disposed in different positions, whereby the gap between the mixing rods and paddles is changeable for achieving different mixing strengths.

Some materials such as paints and waterproof paints generally need to be blended with other materials before painting. Also, some chemical materials must be mixed with each other in a set ratio. Therefore, a mixer is necessary for mixing these materials. An electric mixer is able to quickly and conveniently mix the materials.

An earlier electric mixer has one single mixing rod driven by a motor. One paddle is connected with a rear end of the mixing rod for extending into the materials to blend the same.

The above single-paddle mixer is operated at lower speed and can hardly fully mix the materials. Therefore, a twin-paddle electric mixer has been developed for increasing the mixing speed and more fully mixing the materials.

The two paddles disposed at the ends of two mixing rods of the twin-paddle electric mixer are preferably counter-rotatable. That is, when one of the paddles clockwise rotates, the other of the paddles counterclockwise rotates. Accordingly, the materials can be more fully mixed at faster speed. Another advantage of such arrangement is that when the paddles rotate in reverse directions, the torque reaction forces created by the paddles will offset each other. Such twin-paddle electric mixer is also applicable to fiber viscous material. After mixed, this material will have no physical strain.

However, in all the existent electric mixers including single-paddle and twin-paddle electric mixers, the paddles are fixedly assembled with the mixing rods. That is, in single-paddle electric mixer, the driving mechanism and relevant units at the top via one single connecting tube is connected with one single mixing rod and one paddle disposed at the end of the mixing rod. In twin-paddle electric mixer, the driving mechanism and relevant units at the top via two connecting tubes are connected with two mixing rods and two paddles disposed at the ends of the mixing rods. With such fixed assembly, when necessary, it is impossible to switch the electric mixer between one-paddle mode and twin-paddle mode. (For example, when it is necessary to use two paddles in the single-paddle electric mixer for mixing materials.)

Furthermore, the materials mixed by the electric mixer may have different viscosities. With twin-paddle electric mixer exemplified, the smaller the gap between the paddles of the mixing rods is, the greater the mixing strength is. Reversely, the larger the gap between the paddles of the mixing rods is, the less the mixing strength is. Preferably, different mixing strengths are applied to the materials with different viscosities. However, the conventional fixed type of electric mixer cannot be selectively adjusted in mixing strength.

### SUMMARY OF THE INVENTION

It is therefore a primary object of the present invention to provide to an electric mixer which is switchable between single-paddle mode and twin-paddle mode. In addition, the mixing rods and paddles thereof can be selectively disposed in different positions, whereby the gap between the mixing rods and paddles is changeable for achieving different mixing strengths.

According to the above object, the electric mixer includes a driving mechanism and a transmission mechanism positioned under the driving mechanism for outputting the power of the driving mechanism and controlling rotational direction of mixing rods and paddles disposed at the ends of the mixing rods. The mixing rods and paddles are mounted under the transmission mechanism. A first connecting tube, a second connecting tube and a third connecting tube are parallelly arranged under bottom face of the transmission mechanism at intervals. The first connecting tube is positioned in the middle of the electric mixer for connecting with and driving a mixing rod and a paddle. The second and third connecting tubes are respectively disposed on two sides of the first connecting tube. Each of the second and third connecting tubes serves to connect with and drive another mixing rod and another paddle. A smaller first gap is defined between the first middle connecting tube and any of the second and third lateral connecting tubes. A larger second gap is defined between the second and third connecting tubes.

The present invention can be best understood through the following description and accompanying drawings wherein:

### BRIEF DESCRIPTION OF THE DRAWINGS

FIG. 1 is a perspective view of a preferred embodiment of the present invention, showing that two mixing rods and two paddles are assembled to form a twin-paddle electric mixer with a larger gap;

FIG. 2 is a perspective view of the preferred embodiment of the present invention, showing that two mixing rods and two paddles are assembled to form a twin-paddle electric mixer with a less gap; and

FIG. 3 is a perspective view of the preferred embodiment of the present invention, showing that one single mixing rod and one single paddle are assembled to form a single-paddle electric mixer.

### DETAILED DESCRIPTION OF THE PREFERRED EMBODIMENTS

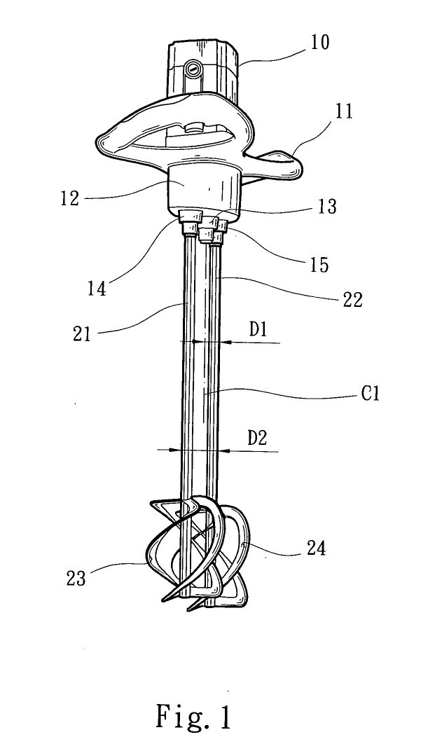

Please refer to FIG. 1. The electric mixer of the present invention includes a driving mechanism 10 and relevant units (such as locating board 11) disposed at top end of the mixer. The electric mixer further includes a transmission mechanism 12 positioned under the driving mechanism 10 for outputting the power of the driving mechanism 10 and controlling the rotational direction of the mixing rods and paddles disposed at the ends of the mixing rods. The mixing rods and paddles are mounted under the transmission mechanism 12. With a twin-paddle electric mixer exemplified, one paddle is controlled to forward rotate, while another paddle is controlled to backward rotate.

A first connecting tube 13, a second connecting tube 14 and a third connecting tube 15 are parallelly arranged under bottom face of the transmission mechanism 12 at intervals. The first connecting tube 13 is positioned in the middle, while the second and third connecting tubes 14, 15 are respectively disposed on two sides of the first connecting tube 13. In this embodiment, a first mixing rod 21 is connected with the second connecting tube 14, while a second mixing rod 22 is connected with the third connecting tube 15. Two paddles 23, 24 are disposed at the ends of the mixing rods 21, 22 and interlaced with each other. The paddles 23, 24 are rotatable in reverse directions.

A smaller first gap D1 is defined between the first middle connecting tube 13 and any of the second and third lateral connecting tubes 14, 15. That is, the distance between the central line C1 of the first connecting tube 13 and the second or third connecting tube 14, 15 is shorter. A larger second gap D2 is defined between the second and third connecting tubes 14, 15.

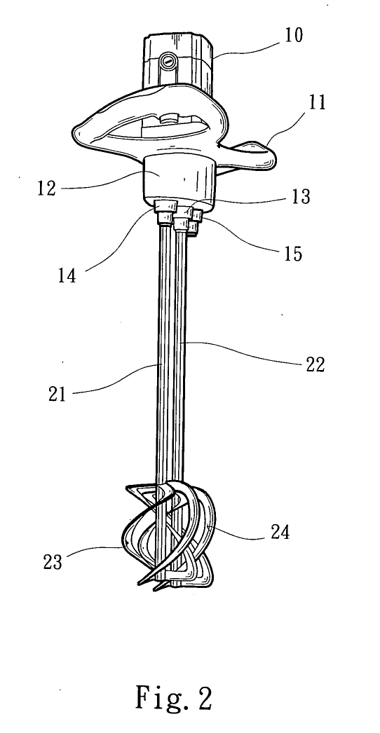

Referring to FIG. 1, when applied to a twin-paddle electric mixer, the first and second mixing rods 21, 22 are respectively connected with the second and third connecting tubes 14, 15, whereby the first and second mixing rods 21, 22 are spaced from each other by the larger gap D2. Alternatively, as shown in FIG. 2, the first and second mixing rods 21, 22 are respectively connected with the first middle connecting tube 13 and any of the second and third connecting tubes 14, 15, whereby the first and second mixing rods 21, 22 are spaced from each other by the smaller gap D1.

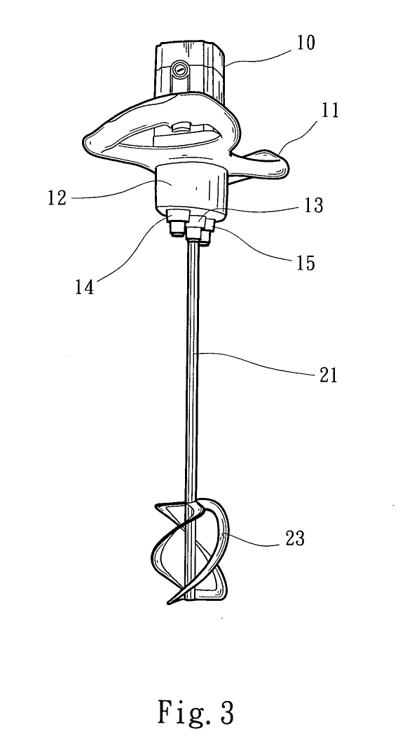

Alternatively, as shown in FIG. 3, one single mixing rod 21 and one single paddle 23 can be connected with one of the connecting tubes to form a single-paddle electric mixer.

According to the above arrangement, the present invention can be assembled to form a twin-paddle electric mixer or a single-paddle electric mixer. In addition, with respect to twin-paddle electric mixer, according to the viscosity of the materials to be mixed, the paddles of the twin-paddle electric mixer can be assembled to have smaller gap for achieving greater mixing strength or have larger gap for achieving less mixing strength.

The above embodiments are only used to illustrate the present invention, not intended to limit the scope thereof. Many modifications of the above embodiments can be made without departing from the spirit of the present invention.

1. An electric mixer comprising a driving mechanism and relevant units disposed at top end of the mixer, the electric mixer further comprising a transmission mechanism positioned under the driving mechanism for outputting the power of the driving mechanism and controlling rotational direction of mixing rods and paddles disposed at the ends of the mixing rods, the mixing rods and paddles being mounted under the transmission mechanism, said electric mixer being characterized in that a first connecting tube, a second connecting tube and a third connecting tube which are parallelly arranged under bottom face of the transmission mechanism at intervals, the first connecting tube being positioned in the middle of the electric mixer for connecting with and driving a mixing rod and a paddle, while the second and third connecting tubes being respectively disposed on two sides of the first connecting tube, each of the second and third connecting tubes serving to connect with and drive another mixing rod and another paddle, a smaller first gap being defined between the first middle connecting tube and any of the second and third lateral connecting tubes, a larger second gap being defined between the second and third connecting tubes.

2. The electric mixer as claimed in claim 1, wherein one mixing rod and paddle thereof are connected with any of the first, second and third connecting tubes.

3. The electric mixer as claimed in claim 1, wherein two mixing rods and paddles thereof are respectively connected with the second and third lateral connecting tubes.

4. The electric mixer as claimed in claim 1, wherein two mixing rods and paddles thereof are respectively connected with the first middle connecting tube and any of the second and third lateral connecting tubes.
